(19) United States
(12) Patent Application Publication
(10) Pub. No.: US 2015/0183379 A1
(43) Pub. Date: Jul. 2, 2015

(54) HAT HOLDER

(71) Applicant: Kevin Hensley, Villa Rica, GA (US)

(72) Inventor: Kevin Hensley, Villa Rica, GA (US)

(21) Appl. No.: 14/587,435

(22) Filed: Dec. 31, 2014

Related U.S. Application Data
(60) Provisional application No. 61/922,656, filed on Dec. 31, 2013.

(51) Int. Cl. B60R 7/10; B60N 2/48

(52) U.S. Cl. CPC B60R 7/10; B60N 2/4876

(57) ABSTRACT

Implementations of a hat holder are provided. In some implementations, the hat holder comprises a headrest portion for securing about a headrest and a hat holding portion for placing a hat thereon. In some implementations, the headrest portion comprises a first strap having a first pocket secured thereon and a second strap having a second pocket secured thereon. In some implementations, the hat holding portion comprises a first leg, a second leg, and a connecting portion connecting the first leg and the second leg. In some implementations, the first pocket is configured to receive a portion of the first leg and the second pocket is configured to receive a portion of the second leg. To secure the hat holder to a headrest, the straps are placed around the headrest and then the first leg and the second leg are inserted into the first pocket and the second pocket of the straps, respectively. The hat is then placed on the hat holding portion.

### CROSS REFERENCE TO RELATED APPLICATION

This application claims the benefit of U.S. patent application Ser. No. 61/922,656, which was filed on Dec. 31, 2013, and is incorporated herein by reference in its entirety.

### TECHNICAL FIELD

This disclosure relates to implementations of a hat holder.

### BACKGROUND

Hats are head coverings are worn for a variety of purposes and have a variety of designs. For example, hats can be worn for functional purposes, for fashion purposes, or as part of a uniform. Hats also come in a variety of types, including but not limited to cowboy, campaign, and Fedora types. The cowboy and campaign-style hats, often worn by military and law enforcement, generally have stiff wide-brims that are flat. Unfortunately, there often is no place in a vehicle for a wearer to place a hat. Thus, wearers usually place the hat on a seat or floor in the vehicle. In these locations, the hat may move around (e.g., while braking) and become inaccessible (e.g., if the hat is placed in a seat, it may fall to the floor beyond the wearer's reach). In these locations, the brim of the hat (especially the wide brims of cowboy and campaign-style hats) may bend when coming into contact with other objects in the car while moving around.

U.S. Patent Application Publication No. 2013/0221712 (“'712 Appl.”) discloses a headrest hanger to hang hats. The headrest hanger comprises hooks mounted on the right side and left side of the headrest. The hooks are retractable inside the headrest. When a wearer desires to hang his/her hat on the headrest hanger, the hooks are deployed from the sides of the headrest to hang the hat on the side of the headrest.

The headrest hat hook in the '712 Appl. has several disadvantages. First, a person has to replace his/her existing headrest to use the headrest hanger of the '712 Appl. Second, the headrest hanger of the '712 Appl. is mechanically complex. Third, the headrest hanger of the '712 Appl. does not securely hold a hat. Fourth, placing a hat on the side of a headrest may obscure a driver's line of sight thereby creating additional blind spots.

### BRIEF DESCRIPTION OF THE DRAWINGS

FIGS. 1-2 illustrate an implementation of a hat holder according to the present disclosure.

FIG. 3 illustrates an implementation of a hat holding portion of the hat holder of FIGS. 1-2.

FIG. 4 illustrates an example method of adjusting the hat holding portion of a hat holder according to the present disclosure.

### DETAILED DESCRIPTION

Implementations of a hat holder are provided. In some implementations, the hat holder comprises a headrest portion for securing about a headrest and a hat holding portion for placing a hat thereon. In some implementations, the headrest portion comprises a first strap having a first pocket secured thereon and a second strap having a second pocket secured thereon. In some implementations, the hat holding portion comprises a first leg, a second leg, and a connecting portion connecting the first leg and the second leg. In some implementations, the first pocket is configured to receive a portion of the first leg and the second pocket is configured to receive a portion of the second leg. To secure the hat holder to a headrest, the first strap and the second strap are placed around the headrest and then the first leg and the second leg are inserted into the first pocket and the second pocket of the straps, respectively. The hat is then placed on the hat holding portion.

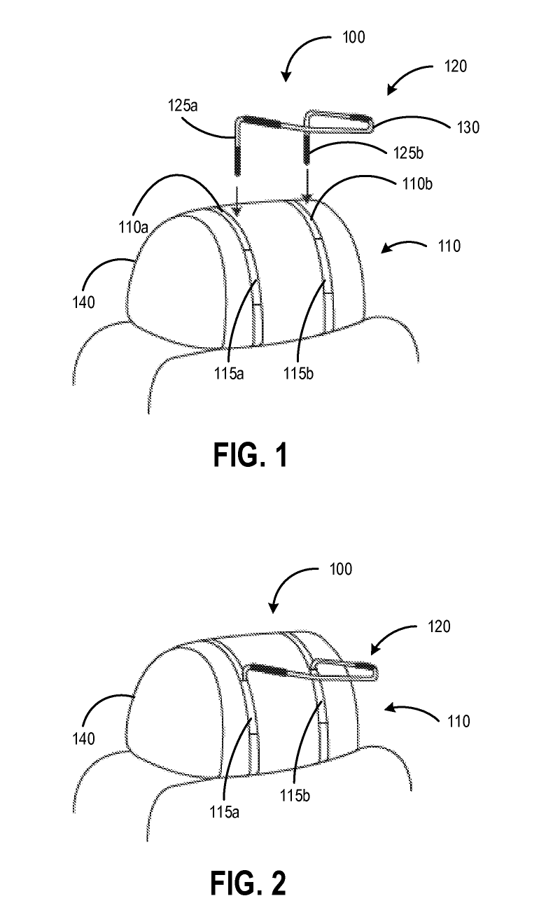

FIGS. 1-2 illustrate an implementation of a hat holder 100 according to the present disclosure. In some implementations, the hat holder 100 comprises a headrest portion 110 for securing about a headrest and a hat holding portion 120 for placing a hat thereon.

In some implementations, the headrest portion 110 comprises a first strap 110a having a first pocket 115a secured thereon and a second strap 110b having a second pocket 115b secured thereon.

In some implementations, the hat holding portion 120 comprises a first leg 125a, a second leg 125b, and a connecting portion 130 connecting the first leg 125a and the second leg 125b.

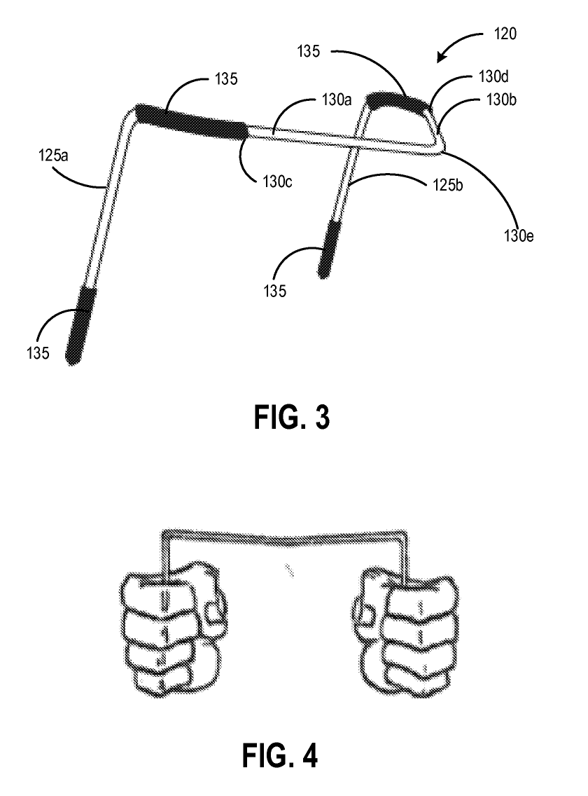

In some implementations, the first leg 125a and the second leg 125b extend in a downward direction. In some implementations, as shown in FIG. 3, the connecting portion 130 comprises a first portion 130a and a second portion 130b extending outwardly in a horizontal direction from the first leg 125a and the second leg 126b, respectively.

In some implementations, the first portion 130a and the second portion 130b include a first bend 130c and second bend 130d, respectively.

In some implementations, the first portion 130a and the second portion 130b extend outwardly from the first leg 125a and the second leg 125b, respectively, to the first bend 130c and second 130d, respectively. In some implementations, the first portion 130a and second portion 130b extend outwardly away from each other from the first leg 125a and the second leg 125b, respectively, to the first bend 130c and second 130d, respectively. In some implementations, the first portion 130a and the second portion 130b extend outwardly in parallel from the first leg 125a and the second leg 125b, respectively, to the first bend 130c and second 130d, respectively.

In some implementations, the first portion 130a and the second portion 130b continue extending outwardly but toward each other from the first bend 130c and second bend 130d, respectively, to a tip 130e. In this way, the connecting portion 130 is widest at the first bend 130c and the second bend 130d.

In some implementations, the hat holding portion 120 is manufactured from wire. In some implementations, the hat holding portion 120 is manufactured from plastic. In some implementations, the hat holding portion 120 is manufactured from any suitable material.

In some implementations, the first pocket 115a is configured to receive a portion of the first leg 125a and the second pocket 115b is configured to receive a portion of the second leg 125b.

In some implementations, each of the straps 110a, b can form a closed loop. In some implementations, each of the straps 110a, b may include recloseable hardware (not shown) to open and close the loop. In some implementations, the hardware may be a buckle. In some implementations, the hardware may be hook and loop fasteners (e.g., Velcro®). In some implementations, the hardware can be any other fastening technology existing or developed in the future to secure the straps in the desired position.

In some implementations, the straps 110a, b may be adjustable. For example the loops may include hardware (not shown) to adjust the size of the loops. For example, the hardware may be a slide adjuster or D-rings. In some implementations, the hardware can be any known of future developed hardware for adjusting straps.

In some implementations, the straps 110a, b may be elastic or stretchable with no hardware to adjust.

In some implementations, the straps 110a, b may manufactured from nylon, polypropylene webbing, or any other suitable material.

To secure the hat holder 100 to a headrest 140, as shown in FIG. 1, the straps 110a, b are placed around the headrest 140. In some implementations, the straps 110a, b are adjusted using any hardware provided with the straps to snugly secure to the straps 110a, b to the headrest 140. In some implementations, the straps 110a, b are spaced apart based on the distance between the first leg 125a and the second leg 125b.

Then, as shown in FIG. 2, the first leg 125a and the second leg 125b are inserted into the first pocket 115a and the second pocket 115b of the straps 110a, b, respectively.

In some implementations, the straps 110a, b are positioned such that when the first leg 125a and the second leg 125b are inserted into the first pocket 115a and the second pocket 115b, respectively, the hat holding portion 120 is at a desired position.

In some implementations, to secure a hat to the hat holder 100, with the interior of a hat facing the hat holding portion 120, position the widest portion of the hat's interior opening to receive the hat holding portion 120 as the hat is moved toward the headrest 140. In some implementations, the bends 130c, d of the hat holding portion 120 may make contact with the interior surface of the hat thereby securing the hat to the hat holding portion 120. In some implementations, once the hat holding portion 120 has been inserted into the interior of the hat, the hat may be pushed down so that the bends 130c, d of the hat holding portion 120 may make contact with the interior surface of the hat thereby securing the hat to the hat holding portion 120.

In some implementations, the hat holding portion 120 may include tubing 135 at one or more locations on the hat holding portion 120. For example, in some implementations, tubing 135 may be located on the ends of the first leg 125a and second leg 125b to, for example, protect the pockets on the straps. In some implementations, tubing 135 may be located on a portion of the first portion 130a and the second portion 130b of the connecting portion 130 to provide additional friction to secure a hat to the hat holding portion 120. In some implementations, the tubing may be heat shrink tubing or any other material to provide additional surface friction or protection.

In some implementations, as shown in FIG. 4, the width of the hat holding portion 120 may be adjusted to fit a hat. The width of the hat holding portion 120 may be adjusted by moving the first portion 130a and second portion 130b of the hat holding portion 120 toward or away from each other. In some implementations, this may be achieved by grasping the first leg 125a and the second leg 126b of the hat holding portion 120 in each hand and pulling the hands together or apart.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A hat holder comprising:
a headrest portion comprising a first strap having a first pocket secured thereon and a second strap having a second pocket secured thereon; and
a hat holding portion comprising a first leg, a second leg, and a connecting portion connecting the first leg and the second leg,
wherein the first leg and the second leg extend in a downward direction and the connecting portion comprises a first portion and a second portion extending outwardly in a horizontal direction from the first leg and the second leg; and
wherein the first pocket is configured to receive a portion of the first leg and the second pocket is configured to receive a portion of the second leg.

2. The hat holder of claim 1 wherein the first portion and the second portion of the connecting portion include a first bend and a second bend, respectively, and the first portion and second portion extend outwardly from the first leg and the second leg, respectively, to the first bend and second, respectively.

3. The hat holder of claim 2 wherein the first portion and the second portion of the connecting portion extend outwardly and toward each other from the first bend and the second bend, respectively.

4. The hat holder of claim 1 further comprising tubing at one or more locations on the hat holding portion.

5. The hat holder of claim 4 wherein the tubing is located on the ends of the first leg and second leg.

6. The hat holder of claim 4 wherein the tubing is located on a portion of the first portion and the second portion of the connecting portion.

7. A method of securing the hat holder of claim 1 to a headrest, the method comprising:
placing the first strap and the second strap around a headrest; and
inserting the first leg and the second leg of the hat holding portion into the first pocket and the second pocket of first strap and the second strap, respectively.

8. A method of claim 7 further comprising securing a hat to the hat holder of claim 1 further comprising facing and positioning the interior of a hat toward the hat holding portion and moving the hat toward the headrest so that the interior of the hat receives a portion of the hat holder portion.
